(19) United States
(12) Patent Application Publication
(10) Pub. No.: US 2024/0175888 A1
(43) Pub. Date: May 30, 2024

(54) LOADING AND UNLOADING UNIT FOR SAMPLE RACKS

(71) Applicants: STRATEC SE, Birkenfeld (DE); Instrumentation Laboratory Company, Bedford, MA (US)

(72) Inventors: Daniel Ahr, Birkenfeld (DE); Thomas Lowien, Birkenfeld (DE); Christopher Almy, JR., Bedford, MA (US); Joshua A. Schreve, Bedford, MA (US); Alberto Gomez Martinez le Lecea, Bedford, MA (US); Benjamin E. Newton, Bedford, MA (US)

(21) Appl. No.: 18/521,328

(22) Filed: Nov. 28, 2023

Related U.S. Application Data
(60) Provisional application No. 63/428,632, filed on Nov. 29, 2022.

(30) Foreign Application Priority Data
Nov. 30, 2022 (LU) 103047

(51) Int. Cl. G01N 35/04

(52) U.S. Cl. CPC G01N 35/04; G01N 2035/0465

(57) ABSTRACT

A system comprising a tray and methods of loading and unloading units for sample racks. The system provides a tray for loading and unloading of samples to a system, wherein the tray comprises a base plate comprising on its upper surface a longitudinal extending guiding rail which is arranged closer to one of the two longitudinal sides of the tray, wherein the tray comprises at least one element that is configured to extend through an opening in the upper surface of the base plate, when the tray is lifted from a surface. Further, a system, comprising a tray as described above; and at least one rack comprising on its lower surface an acceptance slot configured for accommodating a guiding rail of the tray, and a loading area comprising two toothed conveyer belts arranged in a distance corresponding to the trays width.

### CROSS-REFERENCE TO RELATED APPLICATION

The present application claims priority to U.S. Provisional Application No. 63/428,632 filed on Nov. 29, 2022, and Luxembourg Patent Application No. LU 103047 filed on Nov. 30, 2022. The aforementioned applications are hereby incorporated by reference in their entirety.

### BACKGROUND OF THE INVENTION

### Field of the Disclosure

The disclosure relates to a tray, a system comprising the tray and methods of loading and unloading units for sample racks.

### Brief Description of the Related Art

A number of companies produce automated analyzer systems for use in clinical diagnostics and life sciences. Such systems are used to analyze patient samples comprising biochemical liquids, for instance. The samples are handled in so-called sample tubes or containers, which in turn are placed into racks for their handling. For simplicity, tubes are used in the following description. However, any type of container suitable for holding a sample, e.g., for sample transfer, preparation, storage, or testing, can be used in connection with the methods and systems of the present disclosure.

Tube racks belong to laboratory equipment, and they are used to hold multiple containers like tubes upright at the same time. They are used for safe storage of the tubes and to ease the transport of multiple tubes. Tube racks also ease the organization of the tubes and provide support for the tubes being worked with.

Tube racks are known in different sizes, compositions, materials, and color. The racks for tubes are often made of metal wires, but they can also be made of plastic, polystyrene, foam, fiberglass, and polypropylene. Tube racks come in the form of a classic rack, an interlocking cubical form, a stackable form, a tube drying rack, a slant rack, and a 1-well rack.

Tube racks will often have to be loaded or unloaded into automated analyzer systems through specific devices or units of such systems allowing for a safe application of the racks to the system. In high throughput systems, many racks are to be handled, but the handling will also have to be done continuously.

Tubes for loading to a system are usually placed in a rack apart from the automated analyzer system and will be loaded following the completion of a rack. For transporting the racks to the automated analyzer system or a connected device for loading racks, they are often placed onto a tray or into a carriage. After loading the trays to the automated analyzer system or a connected device for loading racks, they are moved on a conveyer belt, by grippers, or other means configured for moving racks.

Disadvantages of the known system for handling racks in labs relate to the risk of contamination of samples due to manual handling of the racks containing sample tubes. Using a gripper for automated handling of racks bears the risk of a collision while moving a rack. Moreover, multiple and frequent manual and/or automatic interactions with sample tubes during their loading process introduce a risk of disruption to sample integrity—the delicate separation between red blood cells and blood plasma necessary in many blood tests.

Further, a tray attached to the front of the device for loading racks increases the distance between the user and the loading device. For small persons, pushing over can be cumbersome. A gripper or pushing lever can be used to transport/push the racks into the analyzer. From a safety point of view, this solution has disadvantages compared to a conveyor belt. If the racks move against a stop (e.g., the users' hand), the lever still pushes forward, and the user can thus be trapped between the racks or by the lever itself. The disadvantage of this solution is that the position and orientation of the lever/gripper must always be included in the loading scenario. The lever must be in a position in which loading of the racks is possible.

Published European patent application EP 2 357 481 A1 discloses a rack transport system that horizontally slides a rack tray holding and storing a plurality of specimen containers, allowing the rack tray to be safely placed on a rack tray set section. For this purpose, a rack transport system using a rack tray having a rack dropout-preventing mechanism includes a rack tray set section that has a lock cancelling mechanism of the rack dropout-preventing mechanism and on which the rack tray that arranges and holds a plurality of racks supporting a plurality of specimen containers is placed, and a projection section serving as a lock cancelling button of the rack dropout-preventing mechanism is formed at a position where the rack tray that holds and stores the plurality of racks supporting the plurality of specimen containers is slid to be able to be set in the rack tray set section.

Published Japanese patent Application JP H10 123146 A discloses a blood-sampling tube for accommodating blood or urine which is mounted to a rack, the rack is moved horizontally from a track for mounting, and the falling-off from the opening of the tray is prevented by a stopper. A coil spring is passed through an operation rotary shaft of the stopper of the tray before installation, the falling-off of the stopper is constantly prevented by the force, and a cover is provided to prevent the stopper from being released easily from the outside. To release the stopper, a pin is provided at a tray installation part and the tray is placed, thus rotating the stopper around the rotary shaft and releasing the falling-off prevention mechanism. As a result, the falling-off of the tray can be prevented as far as the stopper is released by the pin, so that blood and urine in the blood-sampling tube can be protected.

Thus, there is a need for a system allowing to safely and directly apply many racks to a system.

### SUMMARY OF THE INVENTION

The present disclosure provides a tray for loading and unloading of samples to a system, wherein the tray comprises a base plate comprising on its upper surface a longitudinal extending guiding rail which is arranged closer to one of the two longitudinal sides of the tray, wherein the tray comprises at least one element that is configured to extend through an opening in the upper surface of the base plate, when the tray is lifted from a surface.

Another object of the present disclosure relates to a system, comprising a tray for loading and unloading of samples to a system, wherein the tray comprises a base plate comprising on its upper surface a longitudinal extending guiding rail which is arranged closer to one of the two longitudinal sides of the tray, wherein the tray comprises at least one element that is configured to extend through an opening in the upper surface of the base plate, when the tray is lifted from a surface; and at least one rack comprising on its lower surface an acceptance slot configured for accommodating a guiding rail of the tray; and a loading area comprising two toothed conveyer belts arranged in a distance corresponding to the trays width.

The system according to the present disclosure may comprise a guiding rail and acceptance slot which comprise an end which is broader than its connecting part to a lower side of the rack for the acceptance slot or to the upper surface of the base plate for the guiding rail.

The system according to the present disclosure may comprise toothed belts that are arranged in a height so that a gap is present between the at least one rack and the upper surface of the tray's base plate.

The system may also comprise a loading area comprising a counterpart on its upper surface for retracting the at least one element.

The system may comprise in an embodiment an element that is configured to retract when the tray is placed onto a surface.

The element of a tray of a system according to the present disclosure can be a rocker which is located below the upper surface of the base plate and is connected through an axis of rotation to the tray wherein the rocker comprises on one end a latch; or a spring loaded pin.

The present disclosure relates also to system with a tray as described above, comprising at least two elements, wherein the at least two elements are arranged in a distance corresponding to a predefined length of a stack of racks.

It is also envisaged that the rocker is spring loaded or the rocker's end opposite the end with the latch comprises a weight.

In a further embodiment of a tray of a system according to the present disclosure, the rocker's end opposite the end with the latch comprises a stop which is a perpendicular extending elongation of the rocker.

The tray of a system may also comprise in an embodiment two differently formed rockers.

In a further aspect, the tray of a system according to the present disclosure may comprise a C-shaped handle.

Another embodiment relates to a system with a tray, wherein the guiding rail comprises an end which is broader than the connecting part to the base plate. The guiding rail can be T-shaped.

Still other aspects, features, and advantages of the present disclosure are readily apparent from the following detailed description, simply by illustrating preferable embodiments and implementations. The present disclosure is also capable of other and different embodiments and its several details can be modified in various obvious respects, all without departing from the spirit and scope of the present disclosure. Accordingly, the drawings and descriptions are to be regarded as illustrative in nature, and not as restrictive. Additional objects and advantages of the disclosure will be set forth in part in the description which follows and in part will be obvious from the description or may be learned by practice of the disclosure.

### BRIEF DESCRIPTION OF THE FIGURES

The disclosure will be described based on figures. It will be understood that the embodiments and aspects of the disclosure described in the figures are only examples and do not limit the protective scope of the claims in any way. The disclosure is defined by the claims and their equivalents. It will be understood that features of one aspect or embodiment of the disclosure can be combined with a feature of a different aspect or aspects of other embodiments of the disclosure, in which:

FIG. 1 shows a system according to the disclosure comprising a tray and a rack onto the tray.

FIGS. 2A and 2B show schematically an embodiment of a latch when the tray is above a surface (FIG. 2A), or the tray is placed onto a surface (FIG. 2B).

FIGS. 3A and 3B shows schematically an embodiment of a latch with a stop when the tray is above a surface (FIG. 3A), or the tray is placed onto a surface (FIG. 3B).

FIGS. 4A-4B show schematically an embodiment of a latch with weight when the tray is above a surface (FIG. 4A), or the tray is placed onto a surface (FIG. 4B).

FIG. 5 shows schematically an embodiment with identical latches on both sides.

FIG. 6 shows schematically an embodiment with differently configured latches on both sides.

FIG. 7 shows the latches during the loading of a tray.

FIG. 8 shows an embodiment with a C-shaped handle of a tray.

FIG. 9 shows a system according to the present disclosure, which is placed into a loading area of an automated analyzer system.

FIG. 10 shows that racks protrude above the tray's base plate so that they can rest on belts of the loading area.

FIG. 11 a loading area that is intended for inserting trays (not shown) into the device and removing them again.

FIG. 12 shows a loading area comprising a counterpart for retracting latches.

FIG. 13 shows a loading area configured for the unloading of trays.

FIG. 14 shows a perspective view into the loading area and storage area with an empty tray that is inserted into the loading area.

### DETAILED DESCRIPTION OF THE INVENTION

The technical problem is solved by the independent claims. The dependent claims cover further specific embodiments of the disclosure.

The term tube refers within the present disclosure to a container that provides cavities, receptacles, or recesses for receiving a fluid which can be a liquid like a patient sample for instance. The term fluid refers to a liquid or gas which both may comprise solids like magnetic particles. A sample may be any biochemical liquid like whole blood, plasma, urine, lymph, or saliva.

The present disclosure provides a system suitable for directly placing prepared racks comprising tubes from a tray to a conveyor belt in a device for loading racks or directly to an automated analyzer system. Manual insertion of individual racks is thus no longer necessary. The racks are automatically conveyed into the device or the automated analyzer system, respectively, and will be automatically transferred back onto the tray after the analysis is completed. The user only needs to load and unload the trays into the device or the automated analyzer system. The racks or sample tubes themselves will not have to be moved manually by the user.

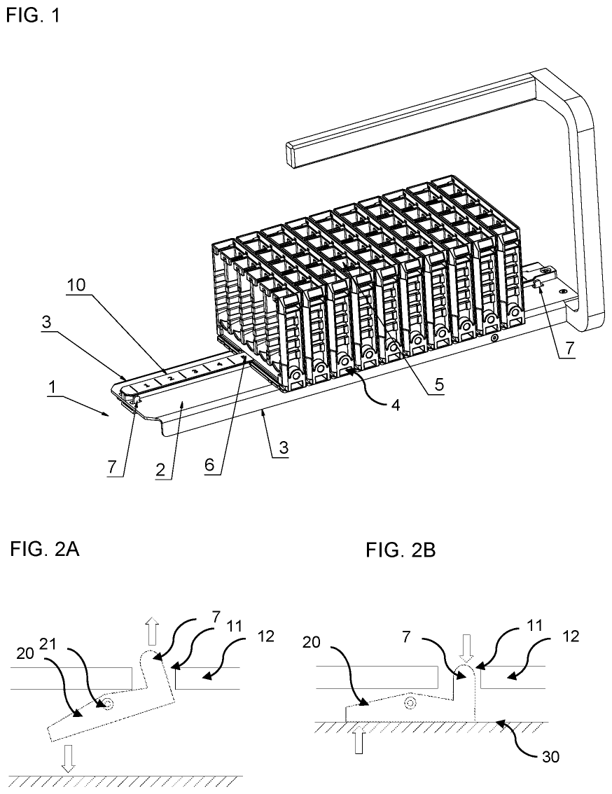

A first aspect of a system according to the present disclosure relates to a tray 1 which can be part of a system shown in FIG. 1. According to the present disclosure, the system comprises a tray 1 and a rack 5 for placing it onto the tray 1. Racks 5 are placed sidewise on the upper surface of a base plate 2 of tray 1. A guiding rail 10 is arranged onto the upper surface of the tray's base plate 2.

The guiding rail 10 is located asymmetrically on base plate 2 of tray 1 within the meaning that the guiding rail 10 has a small distance to one longitudinal extending side 3. Racks 5 may provide an acceptance slot 6 which is also arranged with a smaller distance to one of its narrow sides 4 so that the racks 5 or stacks of racks 5 can only be placed in a single, predetermined orientation onto tray 1, thereby ensuring a correct rack orientation.

The shape and fit between guiding rail 10 and rack acceptance slot 6 are configured for ensuring that the racks 5 cannot vibrate excessively during their transport on the tray 1. An example for such a configuration is a T-shaped guiding rail 10 and an acceptance slot 6 having a corresponding shape. It is obvious for a person having ordinary skill in the art that an appropriate shape for guiding rail 10 and acceptance slot 6 comprises an end of the respective structure which is broader than the connecting part of the structure to the base plate in case of the guiding rail 10 and into the body of the tray in case of the acceptance slot 6.

Additionally, elements like latches 7 at both sides of tray 1 can ensure that the racks 5 cannot fall off the tray 1 when it is carried. When loading racks 5 onto tray 1, latches 7 are retracted, allowing the rack 5 or stacks of racks 5 to slide onto the guiding rail 10 and thus onto the upper surface of base plate 2 of tray 1. When the tray 1 is lifted, the elements which can be latches 7 as shown in FIG. 1 extend for fixation of the stack of racks 5 so that a safe transport of the stack of racks 5 is ensured.

FIGS. 2A and 2B show schematically an embodiment of a latch 7 when the tray 1 is above a surface 30 (FIG. 2A) or the tray 1 is placed onto a surface 30 (FIG. 2B) which can be the upper surface 30 of base plate 2 of tray 1. Latch 7 comprises a rocker 20 (comp. FIGS. 2A and 2B). The rocker 20 moves around axis 21, through which the rocker 20 is connected to the tray 1. The rocker 20 is preloaded by spring force or gravity. The latches 7 extend by spring force or gravity. They retract by a contact of the end of a rocker 20 opposite the end with a latch 7 with a surface 30 pushing the end of rocker 20 so that latches 7 move into an opening 11 in base plate 2 of tray 1 (not shown in FIGS. 2A and 2B). The arrows in FIGS. 2A and 2B indicate the direction of the movements of the rocker's ends.

In a so-called idle state, the spring (not shown in detail) is preloaded and the latch 7 is extended with one end above the surface of the base plate 2 (comp. FIG. 2A). The latch 7 is actuated when the tray is placed onto a surface 30. When the tray is set down, its own weight exerts sufficient pressure on rocker 20 so that the latch 7 retracts into opening 11 of base plate 2 of tray 1 (comp. FIG. 2B).

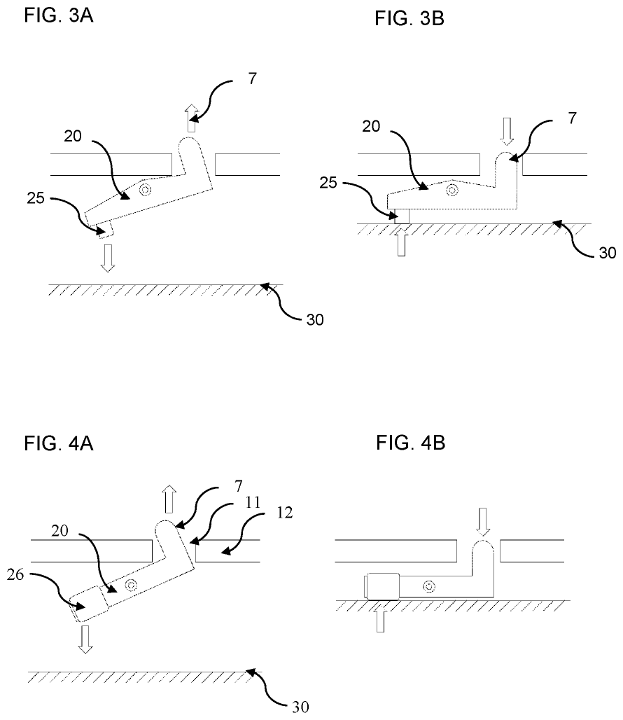

FIGS. 3A-3B show schematically an embodiment of a latch 7 with a stop 25 when the tray 1 is above a surface 30 (FIG. 3A) or the tray 1 is placed onto a surface 30 (FIG. 3B). To adapt the rockers “switching behavior”, its length and/or geometry can be changed, e.g., by mounting a stop 25 to the rocker's end opposite the end with latch 7 so that the latch 7 is actuated via the stop 25 touching surface 30 when the tray 1 is placed onto a surface 30. It can be taken from FIGS. 3A-3B that the stop 25 is a perpendicular extending elongation from the rocker's end. The length of the elongation can be adapted to the required switching behavior of the rocker.

FIGS. 4A-4B shows schematically an embodiment of a latch 7 with a weight 26 when the tray 1 is above a surface 30 (FIG. 4A) or the tray 1 is placed onto a surface 30 (FIG. 4B). Alternatively, a weight 26 can be used instead of a preloaded spring to keep the latch 7 extended via rocker 20. In this mode of operation, there is a weight 26 located on the rocker's end opposite the end, comprising a latch 7. When the tray is placed onto a surface 30, its own weight activates rocker 20 so that the latch 7 retracts. In addition, a stop 25 can be attached as shown in FIGS. 3A-3B. The arrows in FIGS. 3A-3B and FIGS. 4A-4B indicate the direction of movements. The mass of the weight can be adapted to the required switching behavior of the rocker.

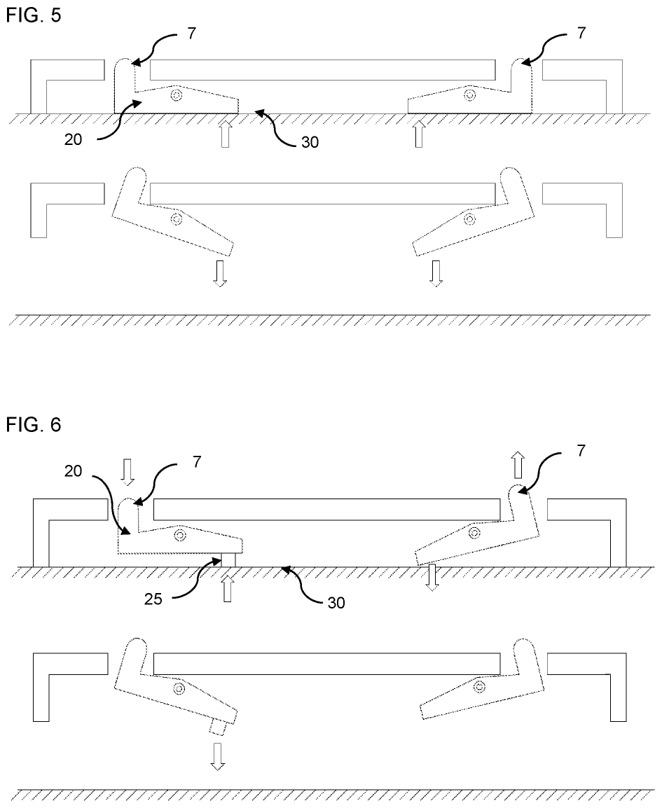

FIG. 5 shows schematically an embodiment with identical latches 7 on both sides so that both latches retract or extend to facilitate the positioning of the racks.

FIG. 6 shows schematically an embodiment with differently formed rockers 20 on both sides wherein one latch 7 is already retracted while the other latch 7 remains extended. FIG. 6 shows an example of such an embodiment with a rocker 20 with latch 7 including a stop 25 (left) and a latch 7 without a stop (right). The right latch 7 remains extended and may serve as a mechanical stop when loading racks (not shown) onto a tray (not shown). When the tray is lifted, both latches extend, ensuring safe transport of the racks (comp. FIG. 6, lower part). In this configuration, the racks can only be loaded from the left side. The arrows in FIG. 6 indicate the direction of movements.

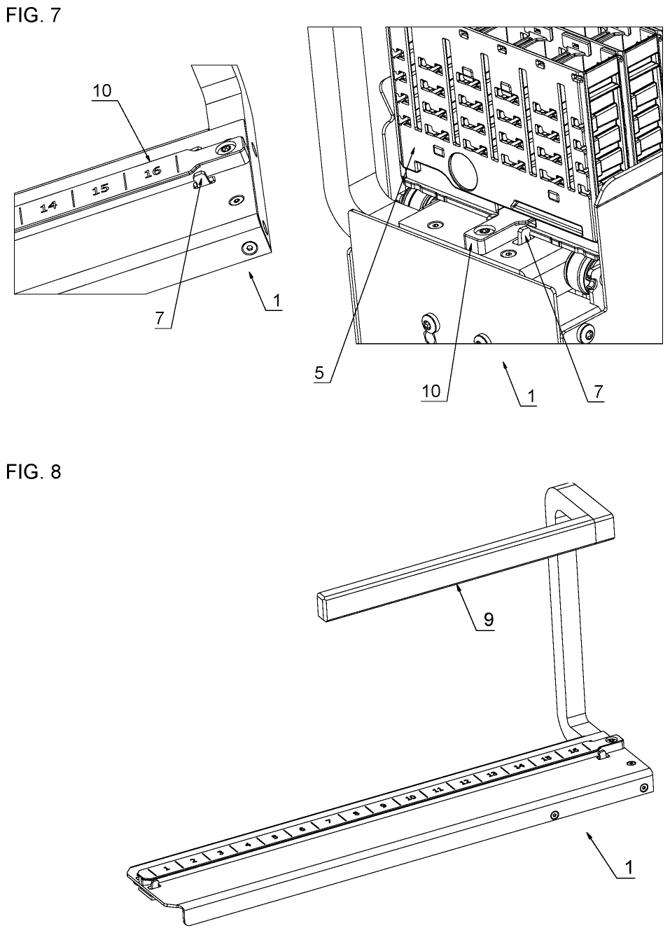

FIG. 7 shows the latches 7 during loading of a tray 1. During loading, the racks 5 are guided onto the guiding rails 10 of the tray 1 passing the retracted latch (not shown) and the first rack 5 will stop at the extended latch 7 which serves as a stop for all racks 5 which may be arranged side by side.

An alternative to a latch as described is a spring loaded pin which retracts when the tray is placed onto a surface and which extends through an opening in the base plate's upper surface when the tray is lifted.

FIG. 8 shows an embodiment of a tray 1 with a C-shaped handle 9 which allows reloading of racks 5 by a user into the loading bay/system via the front of tray 1 at any time. The handle allows a user to grip the tray for moving it. It is obvious for a person having ordinary skill in the art that the shape of the handle is not limited to the shown C-shape and that a closed handle may also be intended.

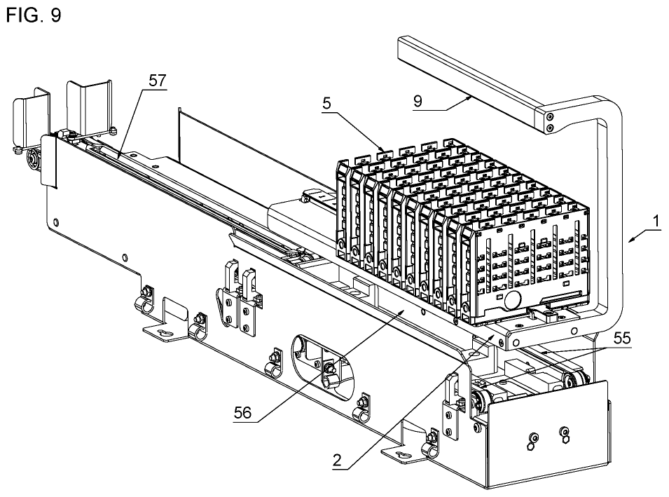

FIG. 9 shows a system according to the present disclosure which is placed into a loading area 56 of an automated analyzer system. The loaded tray 1 is placed into a loading area 56 by a user. Base plate 2 of tray 1 fits exactly between two toothed belts/conveyor belts 55. After tray 1 has been inserted, racks 5 will be moved to a storage area 57. The tray 1 can be removed via handle 9 and a further loaded tray (not shown) may be used to load further racks 5.

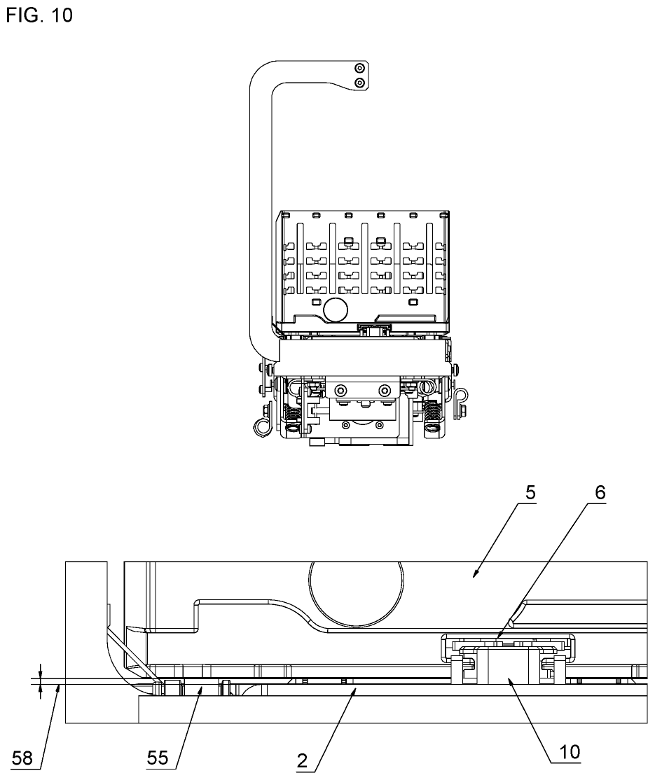

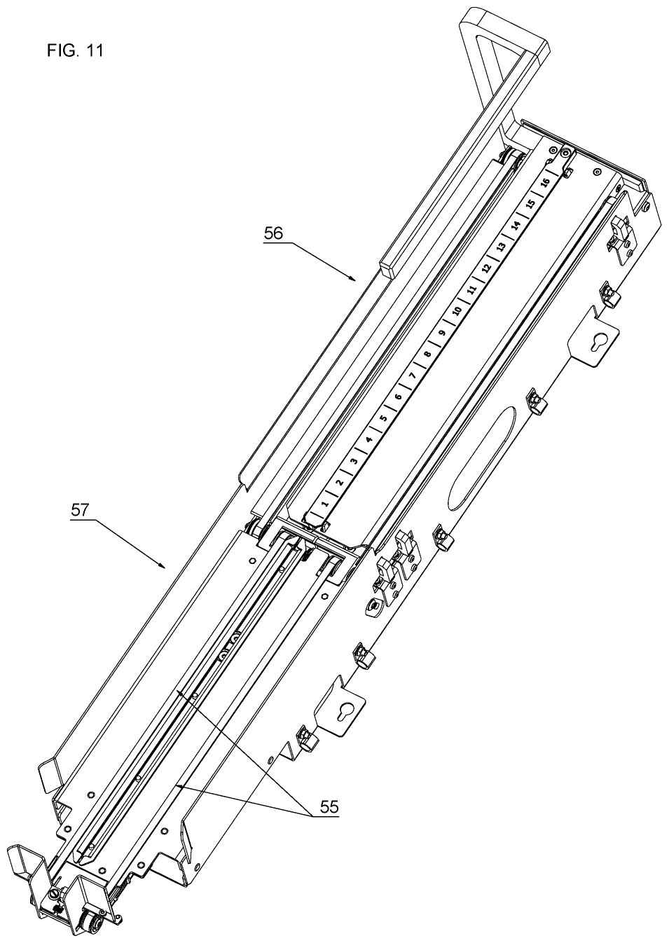

FIG. 10 shows that racks 5 protrude above the tray's base plate 2 so that they can rest on belts 55 of the loading area. These toothed belts are arranged higher than the tray's base plate 2, which means that there is a gap 58 between a rack 5 and the tray's base plate 2. There is enough space between rack 5 and the guiding rail 10 of the tray so that they can be easily pulled out of the rack's acceptance 6.

As already mentioned, there are two areas in the device for loading racks. FIG. 11 shows a loading area 56 which is intended for inserting trays (not shown) into the device and removing them again. This area is accessible to the user. Storage area 57 comprises independent running belts 55. This area comprises racks which have already been loaded for their storage and for their provision to the analyzer for further processing. The user has no access to storage area 57.

The racks in the loading area of the tray can be transported independently from the racks in the storage area of the device and thus a continuous loading and unloading are possible. Thus, the racks can be transported forwards or backwards by the conveyor belt, as needed. The empty tray can be removed and a new one loaded, when all racks have been transported or unloaded from the tray.

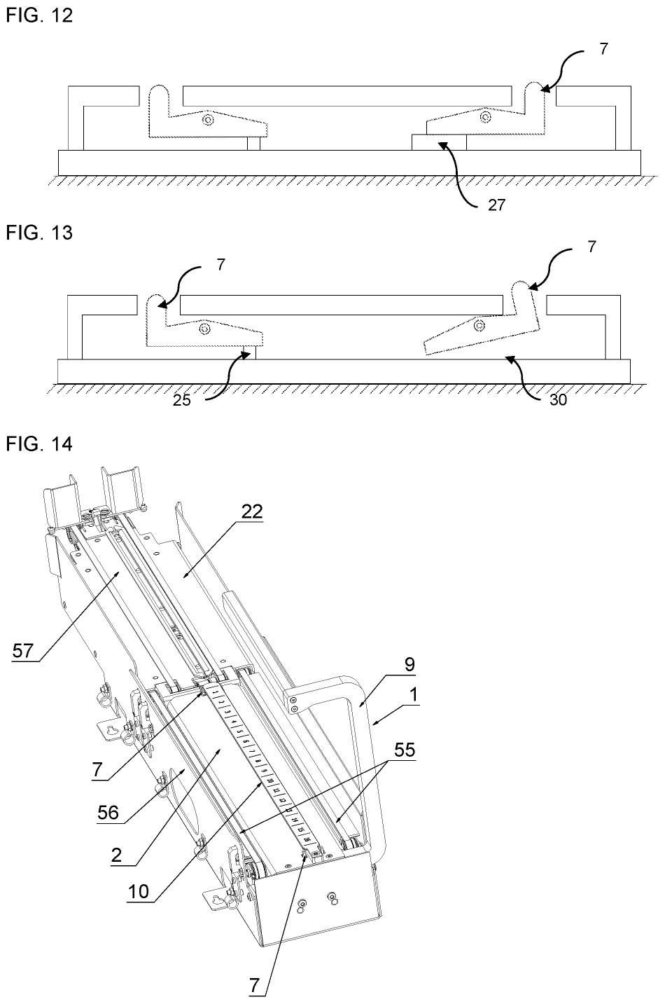

FIG. 12 shows a loading area comprising a counterpart 27 for retracting latches 7. The loading area is configured in a manner that at least the latch unlocks, which is located between loading and storage area. If required, the loading area can be designed with a corresponding counterpart 27 getting in contact with the end of a latch 7 so that at least one or all latches retract when the tray is inserted. During transport to the storage area using a conveyor belt, the racks can be transported through retracted latches.

FIG. 13 shows a loading area configured for the unloading of trays (not shown). When the analysis of samples is finished, the racks can be unloaded again. In this case, it will be useful to configure the loading area in a manner that only the latch 7 between the loading and storage area is unlocked (FIG. 13, left latch). The latch 7 in direction towards the user is locked (FIG. 13, right latch) so that it serves as a stop for racks (not shown) and the racks cannot fall off a tray. In FIG. 13, the left latch towards the storage area has a stop 25 arranged at the end opposite the end with latch 7. Alternatively, a latch with a longer rocker may be used or an additional counterpart (not shown) can be attached to a surface 30 in the loading area. A design using gravity is also possible (comp. FIG. 13).

FIG. 14 shows a perspective view into loading area 56 and storage area 57 with an empty tray 1 which is inserted into loading area 56. Tray 1 fits exactly between the conveyer belts 55 in loading area 56. The asymmetrically on base plate 2 arranged guiding rail 10 with extended latches 7 is shown. Base plate 2 of inserted tray 1 is on the same level as base plate 22 of storage area 57. The guiding rail 10 extends in storage area 57 so that tipping of racks (not shown) is prevented. Tray 1 may have in an embodiment a C-shaped handle 9 so that a user can remove the tray 1 by gripping it by the C-shaped handle 9. An alternative to a C-shaped handle is for instance a closed handle.

For unloading of racks, the conveyor belts in the storage area move the racks from the storage area to the loading area onto an empty tray which can be removed. After racks from a loaded tray have been moved from the loading area to the storage area, the user can remove the empty tray and place a new tray in the loading area.

The present disclosure also encompasses a method for loading and unloading racks from or to a device employing the tray, respectively the system as described above.

The advantages of the disclosure can be summarized as follows:
The tray allows a safe and balanced transport of multiple loaded racks;
The guiding rail, which engages with the bottom side of the racks through an acceptance slot ensures the orientation of the rack in a correct position and prevents the racks from tipping or falling off the tray;
In inserted state of a tray into the loading area of the device, racks can still be reloaded individually via the front of the tray.
Latches on the tray's base plate prevent rack from slipping off the tray during transport.
Two belts in the loading and storage allow continuous transport of racks during loading and unloading of rack on trays or allow individually loading racks via the front of the tray;
The belt drive does not present any safety risks to the user, minimizing the risk of pinching;
the asymmetrical arrangement of the guiding rail allows only loading and unloading of trays in a correct orientation.

The foregoing description of the preferred embodiment of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiment was chosen and described in order to explain the principles of the disclosure and its practical application to enable one skilled in the art to utilize the disclosure in various embodiments as are suited to the particular use contemplated. It is intended that the scope of the disclosure be defined by the claims appended hereto, and their equivalents. The entirety of each of the aforementioned documents is incorporated by reference herein.

### REFERENCE NUMERALS

1 tray
2 base plate
3 longitudinal extending side surface tray
4 narrow side rack
5 rack
6 acceptance slot
7 latch
9 handle
10 guiding rail
11 opening
12 housing
20 rocker
21 axis
22 base plate storage area
25 stop
26 weight
27 counterpart
30 surface
55 conveyer belt
56 loading area
57 storage area
58 gap

What is claimed is:

1. A system, comprising:
a tray for loading and unloading of samples to a system, wherein the tray comprises a base plate comprising on its upper surface a longitudinal extending guiding rail which is arranged closer to one of the two longitudinal sides of the tray, wherein the tray comprises at least one element that is configured to extend through an opening in the upper surface of the base plate, when the tray is lifted from a surface; and
at least one rack comprising on its lower surface an acceptance slot configured for accommodating a guiding rail of the tray; and
a loading area comprising two toothed conveyer belts arranged in a distance corresponding to the tray's width.

2. The system of claim 1, wherein guiding rail and acceptance slot comprise an end which is broader than its connecting part to a lower side of the rack for the acceptance slot or to the upper surface of the base plate for the guiding rail.

3. The system of claim 1, wherein the toothed belts are arranged in a height that a gap is present between the at least one rack and the upper surface of the tray's base plate.

4. The system of claim 1, wherein the loading area comprises a counterpart on its upper surface for retracting the at least one element.

5. The system of claim 1, wherein the element is configured to retract when the tray is placed onto a surface.

6. The system of claim 1, wherein the element is:
a rocker which is located below the upper surface of the base plate and is connected through an axis of rotation to the tray wherein the rocker comprises on one end a latch; or
a spring loaded pin.

7. The system of claim 1, comprising at least two elements, wherein the at least two elements are arranged in a distance corresponding to a predefined length of a stack of racks.

8. The system of claim 6, wherein the rocker is spring loaded or the rocker's end opposite the end with the latch comprises a weight.

9. The system of claim 6, wherein the rocker's end opposite the end with the latch comprises a stop which is a perpendicular extending elongation of the rocker.

10. The system of claim 6, wherein the tray comprises two differently formed rockers.

11. The system of claim 1, wherein the tray comprises a C-shaped handle.

12. The system of claim 1, wherein the guiding rail comprises an end which is broader than the connecting part to the base plate.

13. The system according to claim 12, wherein the guiding rail is T-shaped.
